(19) United States
(12) Patent Application Publication
(10) Pub. No.: US 2025/0050628 A1
(43) Pub. Date: Feb. 13, 2025

(54) COATED PACKAGING MATERIAL HAVING ENHANCED WATER VAPOR TRANSMISSION RATE

(71) Applicant: C.P. Converters, Inc., York, PA (US)

(72) Inventor: Daniel R. COLLINS, II, Victor, NY (US)

(21) Appl. No.: 18/799,122

(22) Filed: Aug. 9, 2024

Related U.S. Application Data
(60) Provisional application No. 63/518,607, filed on Aug. 10, 2023.

(51) Int. Cl. B32B 27/40; B32B 27/20

(52) U.S. Cl. CPC B32B 27/40; B32B 27/20; B32B 2255/26; B32B 2264/062; B32B 2264/30; B32B 2307/4023; B32B 2307/7163; B32B 2307/7246; B32B 2375/00; B32B 2439/70

(57) ABSTRACT

A coated substrate for packaging material that reduces material to the landfill, is compliant for recycling and compostability, and/or enhances Water Vapor Transmission Rate (WVTR). The coated substrate includes a substrate, a barrier coating and an ink layer disposed on the barrier coating. The barrier coating includes a polymeric matrix material and nanoparticles. The barrier coating provides a water vapor transmission rate through the coated substrate lower than the water vapor transmission rate of a substrate having no barrier coating.

### FIELD OF THE INVENTION

The present disclosure is generally directed to a sustainable packaging solution having a barrier coating that provides decreased water vapor transmission rates.

### BACKGROUND OF THE INVENTION

Products such as food and personal care items are provided in packages that provide for access. The packages protect the product from damage during shipping and handling; seal the product to prevent the product from deterioration due to environmental conditions for predetermined periods of time and as a storage vessel. Once opened, while most containers can be reclosed, the effectiveness of the closing arrangement varies widely.

A typical film package for storage of food or personal care items is made from an individual film or a laminate that includes an outer film layer adhesively secured to an inner sealing layer as shown in FIG. 1. The outer layer is usually made from a material, such as ink, that facilitates printing. The inner layer is usually made from a material that enables the package to be sealed. Other layers can also be incorporated. Properties, such as permeability to oxygen and moisture, strength, stiffness and other packaging requirements may dictate material selection. The thickness of the films can contribute to the amount of resistance to moisture permeation. This is important in order to maintain the freshness of baked products. This value is called Moisture Vapor Transmission Rate (MVTR) or Water Vapor Transmission Rate (WVTF). The outer and inner layers are both typically made from plastic film, such as polyethylene or polypropylene. However, known package systems fail to provide sufficient compliance for recycling or compostability.

What is needed is a sustainable packaging solution that also reduces the amount or thickness of the materials utilized. This reduction of material is an ideal compliance to sustainable solutions. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

A coated substrate for packaging material, including a barrier coating according to the present disclosure, that reduces material to the landfill, is compliant for recycling and compostability, and/or enhances Water Vapor Transmission Rate (WVTR).

One embodiment of the present disclosure is directed to a coated substrate for packaging material. The coated substrate includes a substrate, a barrier coating and an ink layer disposed on the barrier coating. The barrier coating includes a polymeric matrix material and nanoparticles. The barrier coating provides a water vapor transmission rate through the coated substrate lower than the water vapor transmission rate of a substrate having no barrier coating.

Another embodiment of the present disclosure includes a package. The package has a package body including a substrate. The substrate has a coating including a matrix material including a polymer and nanoparticles. The barrier coating provides a water vapor transmission rate through the coated substrate lower than the water vapor transmission rate of a substrate having no barrier coating.

Another embodiment of the present disclosure includes a method of forming a coated substrate for packaging material. The method includes providing a substrate and applying a barrier coating to the substrate. The barrier coating includes a polymeric matrix material including a polymer and nanoparticles. An ink layer is applied to the barrier coating. The barrier coating provides a water vapor transmission rate through the coated substrate lower than the water vapor transmission rate of a substrate having no barrier coating.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

FIG. 1 schematically illustrates a conventional ink-coated substrate formed utilizing known materials and processes.

FIG. 2 schematically illustrates a comparative ink-coated substrate having a reduced substrate thickness.

FIG. 3 schematically illustrates an ink-coated packaging material having a coating according to the present disclosure.

FIG. 4 illustrates a method of providing an ink coated substrate according to the present disclosure.

Wherever possible, the same reference numbers will be used throughout the drawings to represent the same parts.

### DETAILED DESCRIPTION OF THE INVENTION

Embodiments of the present disclosure include packaging material, including barrier coated substrates having a reduced water vapor transmission rate (WVTR). The reduced water transmission rate permits downgauging of the substrate, wherein the thickness of the material is reduced to provide the same or comparable sealing properties as a substrate not having the barrier coating. The downgauging is advantageous in compliance for recycling and composability as the amount of material for the packaging solutions to be recycled or composted is substantially reduced. In addition, barrier layers according to the present disclosure, such as nanocellulose varnish compositions, are compliant for recycling and composability. Other advantages include improved shelf life and reduction of plastic.

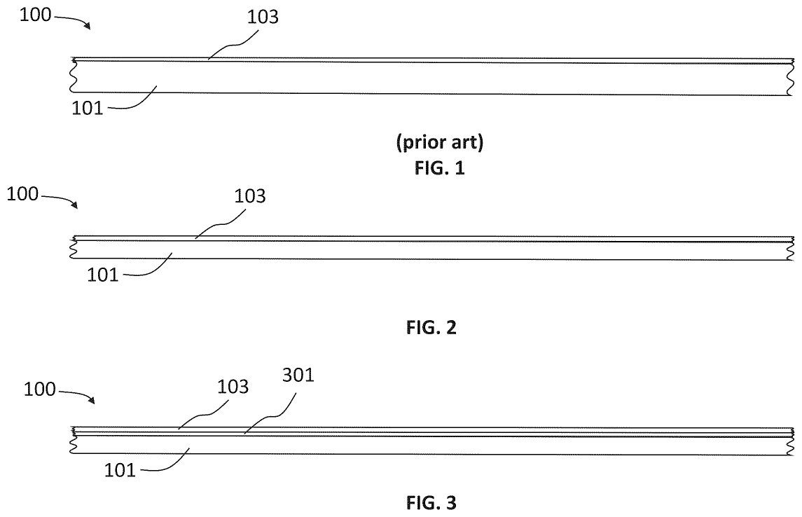

FIG. 1 shows coated substrate 100 for packaging material according to a known process. The coated substrate includes a substrate 101 having an ink layer 103. FIG. 2 shows a coated substrate 100 for packaging material having a reduced substrate 101 thickness. Like in FIG. 1, the coated substrate 100 includes a substrate 101 having an ink layer 103. However, unlike FIG. 1, the thickness of substrate 101 in FIG. 1 is less than the thickness of the substrate 101 in FIG. 1.

FIG. 3 shows a coated substrate 100 according to an embodiment of the present disclosure. The coated substrate 100 includes a substrate 101, a barrier coating 301 and an ink layer 103. Substrate 101 may include any substrate material suitable for use in packaging of goods or products, such as food or personal products. Suitable materials for substrate 101 included, but are not limited to polyethylene (PE), polypropylene (PP), polyethylene terephthalate (PET), and combinations and variations thereof. In addition, the substrate may suitable include, but is not limited to PE/PET. In one embodiment, the material for substrate 101 is oriented polypropylene (OPP). Ink layer 103 may be any suitable known ink material utilized for packaging.

The barrier coating 301 includes a polymeric matrix material including a polymer and nanoparticles. The polymeric matrix material is a material that adheres to the substrate 101, permits printing of the ink layer 103 and is compostable and/or recyclable. In addition, when the barrier coating 301 is applied to substrate 101, the WVTR through the coated substrate 100 is lower than the water vapor transmission rate of a substrate 101 having no barrier coating 301. WVTR may be measured in grams per square meter per day (g/100 in²/day).

The barrier coating 301 includes a polymer chemistry configured to encapsulate the nano particulates. For example, the matrix material may include high molecular weight polymer such as polyurethane. The matrix material provides even nanoparticle distribution, such as to avoid clumping and provides a lower coating weight. Suitable polymeric matrix materials may include polyamide, acrylic or polyurethane polymers. Particularly suitable polymer matrix materials include higher molecular weights. In addition to the matrix material, the barrier coating 301 includes nanoparticles having nano-meter scale particle sizes to enhance the coating. For example, the presence of nanoparticles may further reduce the WVTR values of the coated substrate 100. Suitable nanoparticles may include nanoparticles that food-safe, compostable, recyclable and maintain the sealing and adherence properties of the barrier coating 301. A suitable nanoparticle is nanocellulose. The barrier coating 301 lowers the WVTR at a given thickness, allowing the utilization of lower gauge substrates 101 as the coated substrate 100. Lower gauge substrates 101 in packaging provides less packaging material, which provides a reduction of material to landfills. With respect to composability and/or recyclability, composability and recyclability are defined by local or federal regulations for the disposal or recycle of material. For example, in certain embodiment, the coated substrate 100 according to the present disclosure may be used as packaging material wherein the substrate 101 is less than 100-gauge, equal to or less than 80-gauge, equal to or less than 70-gauge, equal to or less than 60-gauge.

The WVTR values that are provided by the coated substrate 100 according to the present disclosure may include reductions of up to WVTR may be, for example, at least 1%, at least 5%, at least 10%, at least 15%, at least 20% or more. In one embodiment, a coated substrate 100 according to the present disclosure at a given substrate thickness may have a WVTR value that is reduced 13% (from 0.25 to 0.14 g/100 in²/day).

In one embodiment, coated substrate 100 includes a substrate 101, a barrier coating 301 and an ink layer 103 provides desirable WVTR values in packaging, but are devoid of polyvinylidene chloride (PVDC), which is undesirable for disposal in certain jurisdictions.

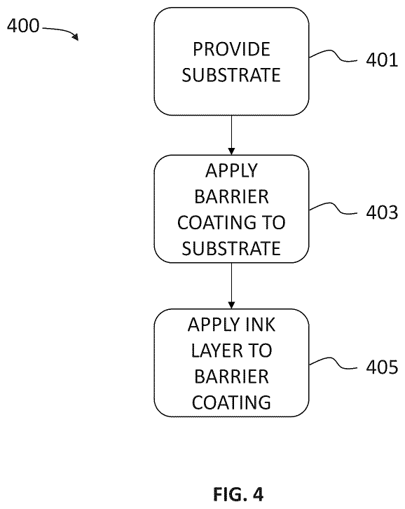

FIG. 4 illustrates a method 400 according to the present disclosure. Method 400 includes providing a substrate 101 (step 401). Thereafter, a barrier coating 301 is applied to the substrate 101 (step 403). Once the barrier coating 301 is applied, an ink layer 103 is applied to the barrier coating 301 (step 405). The barrier coating 301 and the ink layer 103 may be applied, for example, on a printing press utilizing a flexographic printing process. However, the barrier coating 301 and the ink layer 103 may be applied by any known coating technique, including rolling, spraying, dipping or other similar application techniques.

### EXAMPLE

Coating systems were prepared and tested to compare WVTR values of known and comparative coated substrates. Comparative Example 1 was provided as a known packaging material system having a 100-gauge (25.4 microns) substrate of oriented polypropylene (OPP) (see FIG. 1). A conventional ink system was applied on the substrate. Likewise, Comparative Example 2 was the same substrate material, but with an 80-gauge (20.3 microns) substrate and the same ink layer as Comp. Ex. 1 (see FIG. 2). Example 1 according to the present disclosure was provided with the same substrate material as Comp. Ex. 1 and 2, but with the thickness of 80 gauge and a barrier coating between the substrate and the same ink layer as Comp. Ex. 1 and Comp. Ex. 2 (see FIG. 3). The barrier layer of Ex. 1 was a polymeric matrix containing nanocellulose nanoparticles. WVTR values were measured on the coated systems after the coatings had cured.

TABLE 1

| | | Substrate | Substrate | WVTR Value |
|---|---|---|---|---|
| | Layer System | Material | Thickness | (g/100 in²/day) |
| Known | Substrate + | OPP | 100 gauge | 0.15 |
| Packaging | Ink Layer | | | |
| Material - | | | | |
| Comp. Ex. 1 | | | | |
| Reduced | Substrate + | OPP | 80 gauge | 0.25 |
| Guage | Ink Layer | | | |
| Packaging | | | | |
| Material - | | | | |
| Comp. Ex 2 | | | | |
| Inentive | Substrate + | OPP | 80 gauge | 0.13 |
| Packaging | Barrier | | | |
| Material - | Layer + | | | |
| Ex. 1 | Ink Layer | | | |

The WVTR values of the Comparative Examples showed that the WVTR value increased substantially from 0.15 to 0.25 when the gauge was decreased from 100 to 80-gauge thickness. However, with the inclusion of the barrier coating in Ex. 1, the 80-gauge thickness achieved a WVTR value of lower than the 100-gauge known packaging material of Ex. 1.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. A coated substrate for packaging material comprising:
a substrate;
a barrier coating comprising:
a polymeric matrix material; and
nanoparticles;
an ink layer disposed on the barrier coating;
wherein the barrier coating provides a water vapor transmission rate through the coated substrate lower than the water vapor transmission rate of a substrate having no barrier coating.

2. The coated substrate of claim 1, wherein the coated substrate is devoid of polyvinylidene chloride.

3. The coated substrate of claim 1, wherein the polymeric matrix material is a high molecular weight polymer.

4. The coated substrate of claim 1, wherein the polymeric matrix material comprises polyurethane.

5. The coated substrate of claim 1, wherein the nanoparticles include nanocellulose.

6. The coated substrate of claim 1, wherein the water vapor transmission rate through the coated substrate is reduced by at least 5% compared to a substrate having no barrier coating.

7. A package comprising:
a package body including a substrate, the substrate having a coating comprising:
a matrix material including a polymer; and
nanoparticles;
wherein the barrier coating provides a water vapor transmission rate through the coated substrate lower than the water vapor transmission rate of a substrate having no barrier coating.

8. The package of claim 7, wherein the coated substrate is devoid of polyvinylidene chloride.

9. The package of claim 7, wherein the polymeric matrix material is a high molecular weight polymer.

10. The package of claim 7, wherein the polymeric matrix material comprises polyurethane.

11. The package of claim 7, wherein the nanoparticles include nanocellulose.

12. The package of claim 7, wherein the water vapor transmission rate through the coated substrate is reduced by at least 5% compared to a substrate having no barrier coating.

13. A method of forming a coated substrate for packaging material, the method comprising:
providing a substrate;
applying a barrier coating to the substrate, the barrier coating comprising:
a polymeric matrix material including a polymer; and
nanoparticles;
applying an ink layer to the barrier coating;
wherein the barrier coating provides a water vapor transmission rate through the coated substrate lower than the water vapor transmission rate of a substrate having no barrier coating.

14. The method of claim 13, wherein the coated substrate is devoid of polyvinylidene chloride.

15. The method of claim 13, wherein the polymeric matrix material is a high molecular weight polymer.

16. The method of claim 13, wherein the polymeric matrix material comprises polyurethane.

17. The method of claim 13, wherein the nanoparticles include nanocellulose.

18. The method of claim 13, wherein the water vapor transmission rate through the coated substrate is reduced by at least 5% compared to a substrate having no barrier coating.
